(19) United States
(12) Patent Application Publication
(10) Pub. No.: US 2017/0355370 A1
(43) Pub. Date: Dec. 14, 2017

(54) VEHICLE CONTROL SYSTEM

(71) Applicant: TOYOTA JIDOSHA KABUSHIKI KAISHA, Toyota-shi (JP)

(72) Inventor: Chika TSUMORI, Sunto-gun (JP)

(73) Assignee: TOYOTA JIDOSHA KABUSHIKI KAISHA, Toyota-shi (JP)

(21) Appl. No.: 15/593,551

(22) Filed: May 12, 2017

(30) Foreign Application Priority Data
Jun. 10, 2016 (JP) 2016-116450

(51) Int. Cl. B60W 30/18; G06F 17/30; G07C 5/00; B60W 50/00

(52) U.S. Cl. CPC B60W 30/18; B60W 50/0098; G06F 17/30309; G06F 17/30241; G07C 5/008; G06F 17/30598; B60W 2420/42; B60W 2750/40; B60W 2420/52; B60W 2520/14; B60W 2550/406; B60W 2550/40

(57) ABSTRACT

A vehicle control system is provided with: a database configured to store therein, for each vehicle, vehicle data including a plurality of types of information about vehicle operation; a group divider configured to divide the vehicle data of a plurality of vehicles into groups each including similar driving characteristics; a specifier configured to specify to which of the groups a host vehicle belongs, from a running history of the host vehicle; an extractor configured to extract the vehicle data of a vehicle with higher evaluation regarding a predetermined evaluation item, which can be evaluated by using the vehicle data, than that of the host vehicle, from the group specified by the specifier; and a controller configured to control a running aspect of the host vehicle such that it approaches to a running aspect performed on the basis of the vehicle operation indicated by the vehicle data extracted by the extractor.

### CROSS-REFERENCE TO RELATED APPLICATIONS

This application is based upon and claims the benefit of priority of the prior Japanese Patent Application No. 2016-116450, filed on Jun. 10, 2016, the entire contents of which are incorporated herein by reference.

### BACKGROUND OF THE INVENTION

### 1. Field of the Invention

Embodiments of the present invention relate to a vehicle control system configured to control running of a vehicle.

### 2. Description of the Related Art

For this type of apparatus, there is known a technology/technique for improving a predetermined evaluation item by controlling the running of the vehicle (in other words, by supporting vehicle operation). In Japanese Patent Application Laid Open No. 2012-113631, there is proposed a technology/technique in which a variable most contributing to the improvement in the evaluation item, such as fuel consumption, is specified from variables registered in a database, such as acceleration, vehicle speed, accelerator opening degree, and a steering angle, to perform driving support on a host vehicle or a subject vehicle (or the specified variable is changed) in such a manner that the evaluation item is improved.

In the technology/technique described in Japanese Patent Application Laid Open No. 2012-113631, the specified variable varies due to support control. The support control possibly gives discomfort to a driver. Specifically, if support for realizing the running of the vehicle against a certain operation or support for suppressing the running of the vehicle corresponding to the certain operation is given to a driver who prefers the certain operation, then, the driver possibly feels significant discomfort for vehicle behavior. For example, if support for suppressing sudden acceleration is given to a driver who prefers the sudden acceleration, then, it is considered that the driver feels significant discomfort for the vehicle behavior. In this case, even if the evaluation item is improved, drivability is significantly deteriorated, which is technically problematic.

### SUMMARY

In view of the aforementioned problems, it is therefore an object of embodiments of the present invention to provide a vehicle control system configured to control a vehicle in such a manner that the evaluation item is improved while suppressing the deterioration of the drivability.

<1>

The above object of embodiments of the present invention can be achieved by a vehicle control system comprising: a database configured to store therein, for each vehicle, vehicle data including a plurality of types of information about vehicle operation; a group divider configured to divide the vehicle data of a plurality of vehicles into groups each of which includes similar driving characteristics; a specifier configured to specify to which of the groups a host vehicle belongs, from a running history of the host vehicle; an extractor configured to extract the vehicle data of a vehicle with higher evaluation regarding a predetermined evaluation item, which can be evaluated by using the vehicle data, than that of the host vehicle, from the group specified by said specifier; and a controller configured to control a running aspect of the host vehicle in such a manner that the running aspect approaches to a running aspect performed on the basis of the vehicle operation indicated by the vehicle data extracted by said extractor.

According to the vehicle control system in embodiments of the present invention, the vehicle data of the vehicle with higher evaluation regarding the evaluation item than that of the host vehicle is extracted, and the running aspect of the host vehicle is controlled in such a manner that the running aspect approaches to the running aspect performed on the basis of the vehicle operation indicated by the extracted vehicle data. By this, the evaluation of the evaluation item of the host vehicle can be improved.

Moreover, the vehicle data used for the control of the host vehicle is extracted from the group to which the host vehicle belongs (i.e. the group with driving characteristics similar to those of the host vehicle), out of the plurality of groups groped by the driving characteristics. It is thus possible to prevent that the running of the vehicle is controlled on the basis of the vehicle data with significantly different driving characteristics. This can prevent that the control of the vehicle gives discomfort to a driver.

<2>

In one aspect of the vehicle control system according to embodiments of the present invention, wherein said database and said group divider are provided for an external server configured to communicate with the host vehicle, and said specifier, said extractor, and said controller are provided for the host vehicle.

According to this aspect, it is not necessary to perform the storage of a huge amount of vehicle data and the grouping of the vehicle data, on the host vehicle. This can simplify a configuration of the host vehicle, and can keep a low processing capability required for the host vehicle. Moreover, a part of process is performed even on the host vehicle, so a processing capability required for an external server can be kept lower than when an entire process is performed on the external server.

<3>

In another aspect of the vehicle control system according to embodiments of the present invention, wherein said database, said group divider, said specifier, and said extractor are provided for an external server configured to communicate with the host vehicle, and said controller is provided for the host vehicle.

According to this aspect, a configuration other than the controller configured to control the running of the vehicle is provided for the external server. Thus, the configuration of the host vehicle can be further simplified, and the processing capability required for the host vehicle can be kept low.

<4>

In another aspect of the vehicle control system according to embodiments of the present invention, wherein said vehicle control system further comprises a selector configured to select vehicle data including information about vehicle operation performed on a route on which the host vehicle is scheduled to run, from the vehicle data stored in said database, and said group divider is configured to divide the vehicle data selected by said selector, into groups.

According to this aspect, before the grouping, the vehicle data is selected in advance in accordance with the route on which the host vehicle runs. This can reduce the total number of the vehicle data for the grouping, and a process required for the grouping can be simplified.

<5>

In another aspect of the vehicle control system according to embodiments of the present invention, further comprising a changer configured to change the predetermined evaluation item.

According to this aspect, the predetermined evaluation item can be changed, for example, by a switch operation performed by the driver, or the like. Thus, a desired evaluation item can be improved.

Moreover, in controlling the host vehicle on the basis of the extracted vehicle data, the control is performed in view of the plurality of types of information about the vehicle operation. Thus, the predetermined evaluation item can be improved, more effectively, than when only one type of information about the vehicle operation is considered.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram illustrating a configuration of a vehicle control system according to an embodiment;

FIG. 2 is a flowchart illustrating a vehicle control system in a modified example according to the embodiment;

FIG. 3 is a flowchart illustrating a flow of operation on a management center side;

FIG. 4 is a flowchart illustrating a flow of operation on a host vehicle side;

FIG. 5 is a graph illustrating an eigenvalue and a cumulative contribution ratio of each component in principle component analysis;

FIG. 6 is a graph illustrating physical quantities that constitute a first principle component and a weighting factor of each physical quantity;

FIG. 7 is a table illustrating vehicle operation data grouped by evaluation items;

FIG. 8 is a map illustrating variation in average vehicle speed and fuel consumption due to vehicle control; and

FIG. 9 is a graph illustrating a driver operation overwriting rate when the vehicle is controlled.

### DETAILED DESCRIPTION OF THE PREFERRED EMBODIMENTS

A vehicle control system according to embodiments of the present invention will be explained with reference to the drawings.

<Configuration of Vehicle Control System>

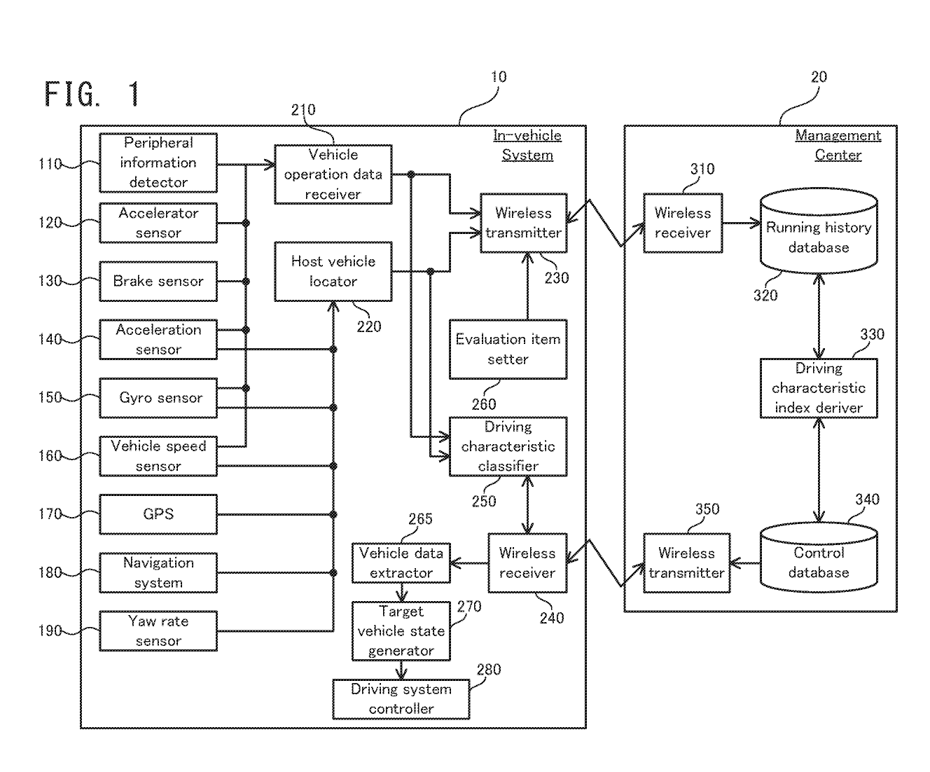

Firstly, a configuration of a vehicle control system according to an embodiment will be explained with reference to FIG. 1. FIG. 1 is a block diagram illustrating the configuration of the vehicle control system according to the embodiment.

In FIG. 1, the vehicle control system according to the embodiment is provided with an in-vehicle system 10 mounted on a vehicle, and a management center 20. The management center 20 is one specific example of the “external server”, and is configured to communicate with a plurality of vehicles each of which is equipped with the in-vehicle system 10.

<Configuration of in-Vehicle System>

The in-vehicle system 10 is provided with a peripheral information detector 110, an accelerator sensor 120, a brake sensor 130, an acceleration sensor 140, a gyro sensor 150, a vehicle speed sensor 160, a Global Positioning System (GPS) 170, a navigation system 180, a yaw rate sensor 190, a vehicle operation data receiver 210, a host vehicle locator 220, a wireless transmitter 230, a wireless receiver 240, a driving characteristic classifier 250, an evaluation item setter 260, a vehicle data extractor 265, a target vehicle state generator 270, and a driving system controller 280.

The peripheral information detector 110 includes, for example, an in-vehicle camera, a millimeter wave radar, a LIDAR, and the like. The peripheral information detector 110 is configured to detect information about a periphery of the vehicle (e.g. information about obstacles, pedestrians, presence of other vehicles, or the like).

The accelerator sensor 120 and the brake sensor 130 are respectively configured to detect operation (or step-in amount) of an accelerator pedal and a brake pedal stepped by a driver of the vehicle.

The acceleration sensor 140, the gyro sensor 150, and the vehicle speed sensor 160 are respectively configured to detect acceleration, angular velocity, and speed of the vehicle.

The GPS 170 is a system configured to obtain information about a vehicle position by using communication with satellites. The navigation system 180 is a system configured to perform navigation (or traveling route guiding) for the driver of the vehicle by using the information about the vehicle position obtained by the GPS 170. The navigation system 180 is configured to obtain various pieces of information by using vehicle-to-vehicle communication and road-to-vehicle communication in addition to the GPS 170.

The yaw rate sensor 190 is configured to detect a yaw rate of the vehicle.

The host vehicle operation data receiver 210 is configured to receive data, which are respectively obtained by the peripheral information detector 110, the accelerator sensor 120, the brake sensor 130, the acceleration sensor 140, the gyro sensor 150, and the vehicle speed sensor 160, as vehicle operation data, and is configured to output the data to the wireless transmitter 230 and the driving characteristic classifier 250. The vehicle operation data includes not only information about vehicle operation itself performed by the driver (e.g. step-in amount of an accelerator pedal, etc.) but also information about a vehicle state realized by the vehicle operation (e.g. vehicle speed, acceleration, etc.).

The host vehicle locator 220 is configured to locate or specify a position of the host vehicle (i.e. the vehicle equipped with the in-vehicle system 10), on the basis of the data respectively obtained by the acceleration sensor 140, the gyro sensor 150, and the vehicle speed sensor 160, the GPS 170, the navigation system 180, and the yaw rate sensor 190. The position of the host vehicle located herein includes not only coordinate information of the host vehicle but also road information about a road around the host vehicle (e.g. information about intersections and curves, etc.). The information about the position of the host vehicle located by the host vehicle locator 220 is configured to be outputted to the wireless transmitter 230 and the driving characteristic classifier 250.

The wireless transmitter 230 is configured to transmit the data on the in-vehicle system 10 side, to the management center 20. The wireless receiver 240 is configured to receive data from the management center 20 side. Specific content of the data transmitted and received by the wireless transmitter 230 and the wireless receiver 240 will be described later in detail in an explanation for operation.

The driving characteristic classifier 250 is configured to specify a group to which the host vehicle belongs, on the basis of the information obtained by the vehicle operation data receiver 210 and the host vehicle locator 220 and on the basis of the data received via the wireless receiver 240 from the management center 20 side. The group herein is determined by grouping performed on the management center 20 side, and the grouping is performed in such a manner that vehicles with similar driving characteristics (i.e. with various similar parameters regarding the driving characteristics) are in a same group. In other words, the driving characteristic classifier 250 is configured to specify a group with driving characteristics similar to those of the host vehicle. Information about the group specified by the driving characteristic classifier 250 is configured to be transmitted to the management center 20 side via the wireless transmitter 230. The driving characteristic classifier 250 is one specific example of the “specifier”.

The evaluation item setter 260 is configured to set an evaluation item (e.g. fuel consumption) which is to be desirably improved by the vehicle control system. The evaluation item is an item in which good or bad performance can be evaluated by using vehicle data. The “vehicle data” is information in which the vehicle operation data (i.e. physical quantities, such as vehicle speed, accelerator opening degree, brake pressure, and acceleration) is linked to the information about the vehicle position. The evaluation item can be selected from a plurality of items, and is set by the operation of the driver of the vehicle (e.g. operation of a not-illustrated switch, etc.). In other words, the evaluation item setter 260 also functions as one specific example of the “changer”. Information about the evaluation item set by the evaluation item setter 260 is configured to be transmitted to the management center 20 side via the wireless transmitter. The embodiment describes an example in which the evaluation item can be selected from the plurality of items by the evaluation item setter 260; however, the evaluation item may be one item set in advance. In this case, the evaluation item setter 260 may not be provided for the vehicle control system.

The vehicle data extractor 265 is configured to extract vehicle data with the highest evaluation of the evaluation item (i.e. the item set by the evaluation item setter 260) from a plurality of vehicle data received via the wireless receiver 240 from the management center 20 side. The vehicle data extracted by the vehicle data extractor 265 is configured to be outputted to the target vehicle state generator 270. The vehicle data extractor 265 is one specific example of the “extractor”.

The target vehicle state generator 270 is configured to generate a target vehicle state, which is a control target of the vehicle control system, on the basis of the vehicle data extracted by the vehicle data extractor 265. The target vehicle state includes information about various parameters (particularly, parameters regarding the vehicle operation) that can be controlled in the vehicle. Information indicating the target vehicle state generated by the target vehicle state generator 270 is configured to be transmitted to the driving system controller 280.

The driving system controller 280 includes a plurality of actuators or the like configured to control driving systems of the vehicle, and is configured to perform control related to vehicle running (or driving support control). The driving system controller 280 is configured to control various driving systems (e.g. an accelerator, a brake, etc.) in such a manner that the vehicle is in the target vehicle state, on the basis of the information indicating the target vehicle state generated by the target vehicle state generator 270. The target vehicle state generator 270 and the driving system controller 280 are one specific example of the “controller”.

Out of the aforementioned parts, each of the vehicle operation data receiver 210, the host vehicle locator 220, the driving characteristic classifier 250, the evaluation item setter 260, the vehicle data extractor 265, and the target vehicle state generator 270 is provided, for example, as a function block of an electronic control unit (ECU).

<Configuration of Management Center>

The management center 20 is provided with a wireless receiver 310, a running history database 320, a driving characteristic index deriver 330, a control database 340, and a wireless transmitter 350.

The wireless receiver 310 is configured to receive the data from the in-vehicle system 10 side. The wireless transmitter 350 is configured to transmit the data on the management center 20 side, to the in-vehicle system 10. Specific content of the data transmitted and received by the wireless receiver 310 and the wireless transmitter 350 will be described later in detail in the explanation for operation.

The running history database 320 is configured as a storage that can store therein vehicle data of a plurality of vehicles. The vehicle data is stored for each vehicle in the running history database 320. The running history database 320 is one specific example of the “database”.

The driving characteristic index deriver 330 is configured to read out the vehicle data related to the plurality of vehicles stored in the running history database 320, and to divide it into groups each of which includes similar driving characteristics. A result of the grouping by the driving characteristic index deriver 330 is configured to be outputted to the control database 340. The driving characteristic index deriver 330 is one specific example of the “group divider”.

The control database 340 is configured as a storage that can store therein the vehicle data grouped in accordance with the driving characteristics. The control database 340 is also configured to transmit the vehicle data corresponding to a predetermined evaluation item out of the stored vehicle data, to the vehicle side via the wireless transmitter 350. The “vehicle data corresponding to the predetermined evaluation item” means information that can influence the predetermined evaluation item, out of various pieces of information about the vehicle operation included in the vehicle data. The vehicle data corresponding to the predetermined evaluation item is typically transmitted by a group unit. The control database 340 is further configured to transmit even a grouping method (i.e. information indicating what kind of criteria are used to perform the grouping) to the in-vehicle system 10 side.

<Modified Example of Vehicle Control System>

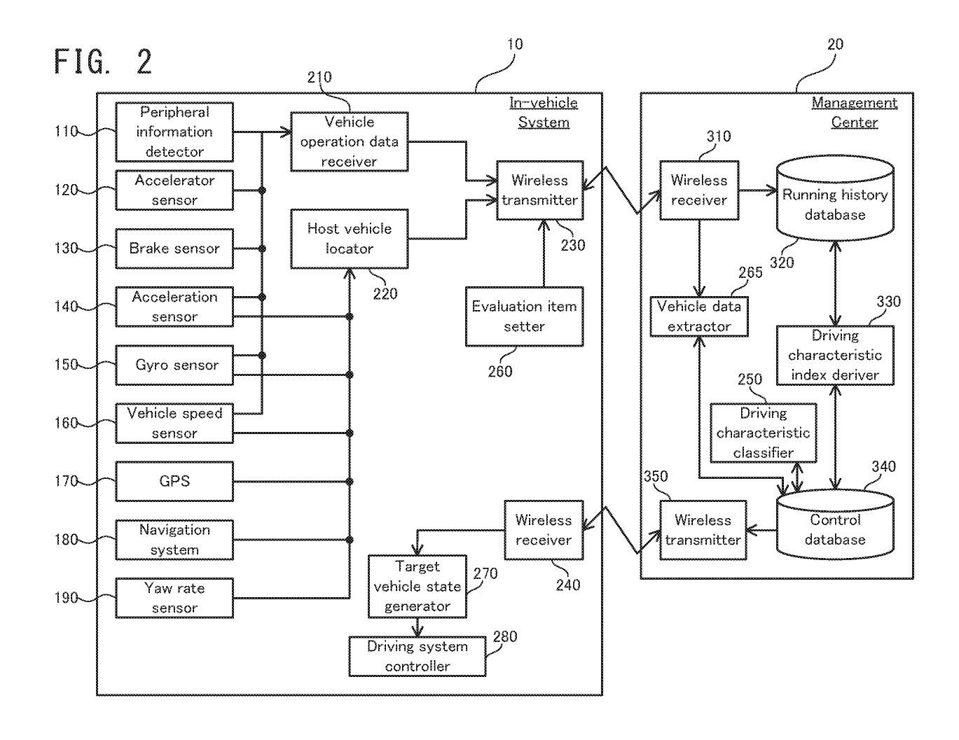

Hereinafter, a vehicle control system in a modified example according to the embodiment will be explained with reference to FIG. 2. FIG. 2 is a flowchart illustrating the vehicle control system in the modified example according to the embodiment.

As illustrated in FIG. 2, the driving characteristic classifier 250 and the vehicle data extractor 265 may be provided not in the in-vehicle system 10 but on the management center 20 side.

The driving characteristic classifier 250 according to the modified example is configured to directly exchange information with the control database 340, thereby specifying a group with driving characteristics similar to those of the vehicle equipped with the in-vehicle system 10. Information to be inputted to the driving characteristic classifier 250 from the vehicle operation data receiver 210 and the host vehicle locator 220 may be transmitted to the management center 20 side from the in-system 10 side via the wireless transmitter 230 and the wireless receiver 310, and may be inputted to the driving characteristic classifier 250, for example, via the running history database 320, the driving characteristic index deriver 330, and the control database 340. Information about the group specified by the driving characteristic classifier 250 is configured to be outputted to the vehicle data extractor 265 via the control database 340.

The vehicle data extractor 265 according to the modified example is configured to directly exchange information with the control database 340, thereby extracting vehicle data with the highest evaluation of the evaluation item from a plurality of vehicle data. The evaluation item set by the evaluation item setter 260 may be inputted to the vehicle data extractor 265 according to the modified example via the wireless transmitter 230 and the wireless receiver 310. The vehicle data extracted by the vehicle data extractor 265 is configured to be outputted to the target vehicle state generator 270 via the wireless transmitter 350 and the wireless receiver 240.

According to the aforementioned modified example, the configuration of the in-vehicle system 10 can be simplified, and processes performed by the driving characteristic classifier 250 and the vehicle data extractor 265 can be performed on the management center 20 side. It is thus possible to keep a low processing capability required for the in-vehicle system 10, in comparison with the vehicle control system illustrated in FIG. 1.

As described above, processing distribution appropriate for circumstances can be realized by arranging a part of the components of the in-vehicle system 10 side, on the management center 20 side. Alternatively, a part of the components of the management center 20 side may be arranged on the in-vehicle system 10 side. The management center 20 may not be an essential component for the embodiment, and the in-vehicle system 10 may be provided with all the components.

<Operation of Vehicle Control System>

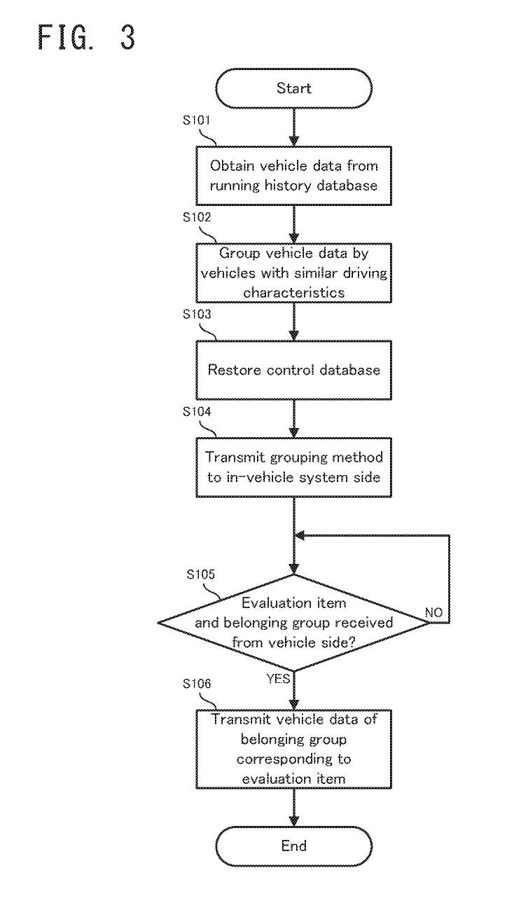

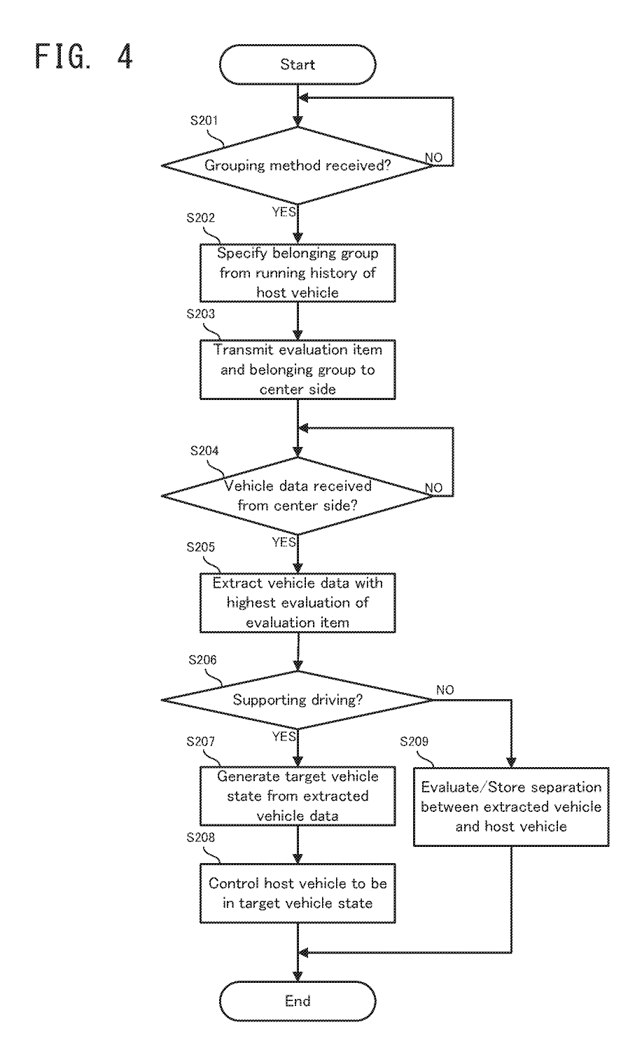

Next, operation of the vehicle control system according to the embodiment (refer to FIG. 1) will be explained in detail with reference to FIG. 3 and FIG. 4. Hereinafter, operation on the in-vehicle system 10 side and operation on the management center 20 side will be alternately explained in order of processes in the vehicle control system. FIG. 3 is a flowchart illustrating a flow of the operation on the management center side. FIG. 4 is a flowchart illustrating a flow of the operation on the host vehicle side.

It is assumed that a sufficient amount of vehicle data is stored in the running history database 320 of the management center 20 at an operation start time point below. In other words, a process is started in a state in which the vehicle data of the plurality of vehicles that can be grouped is stored in the running history database 320.

In FIG. 3, in operation of the vehicle control system according to the embodiment, firstly, the vehicle data is obtained from the running history database 320 by the driving characteristic index deriver 330 of the management center 20 (step S101). On the driving characteristic index deriver 330, the vehicle data of the plurality of vehicles is divided into groups each of which includes similar driving characteristics, by using a method of statistical analysis (e.g. principle component analysis, cluster analysis, etc.) (step S102). A result of the grouping is outputted to the control database 340, and the content of the control database 340 is restored (step S103).

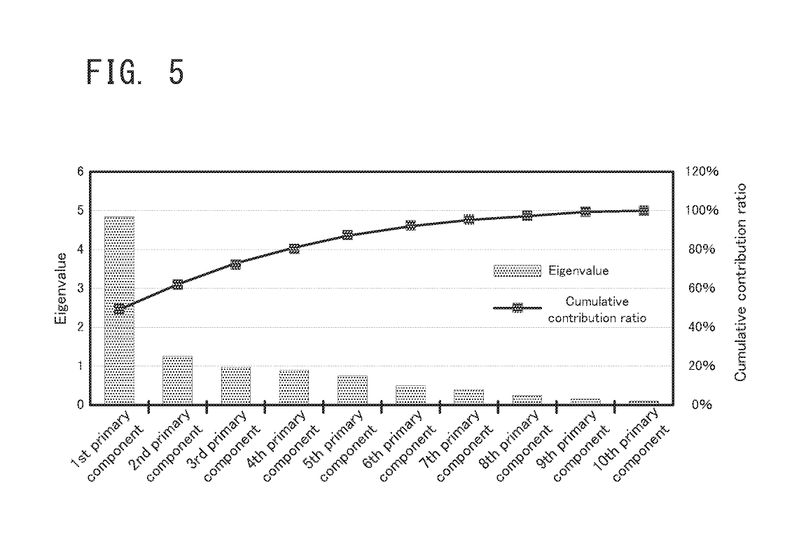

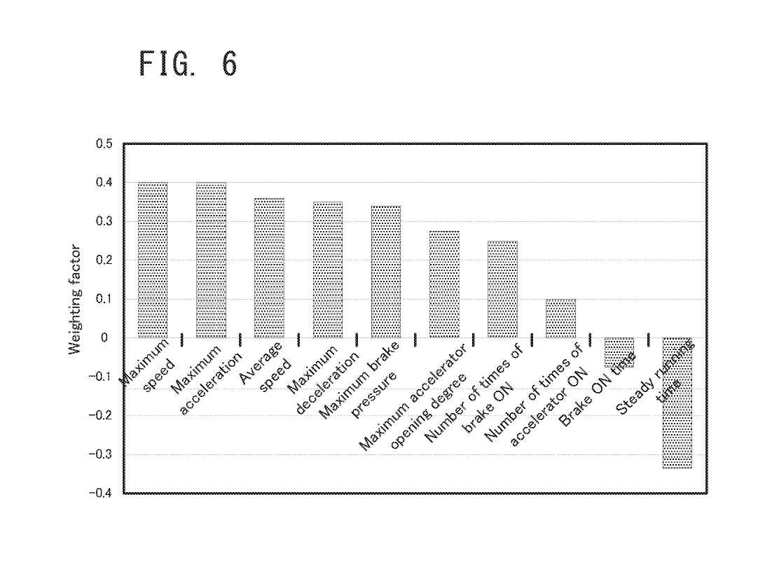

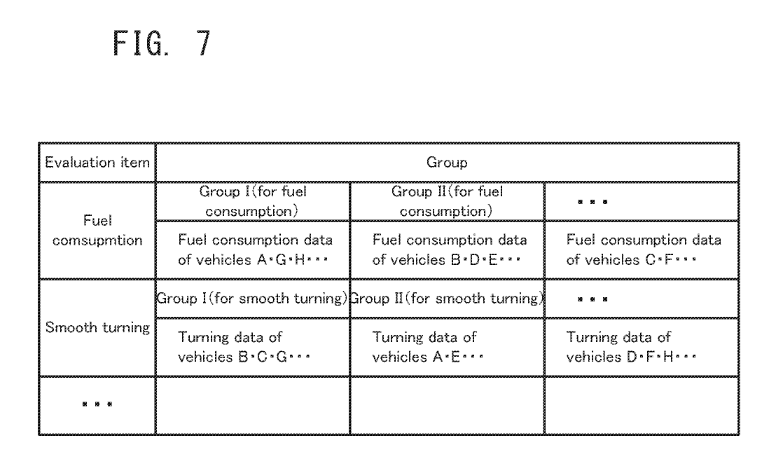

Here, the grouping of the vehicle data will be specifically explained with reference to FIG. 5 to FIG. 7. FIG. 5 is a graph illustrating an eigenvalue and a cumulative contribution ratio of each component in principle component analysis. FIG. 6 is a graph illustrating physical quantities that constitute a first principle component and a weighting factor of each physical quantity. FIG. 7 is a table illustrating vehicle operation data grouped by evaluation items.

As illustrated in FIG. 5, the grouping of the vehicle data can use the principle component analysis. In the principle component analysis, firstly, evaluation parameters used for a corresponding evaluation item are selected from various parameters included in the vehicle data (e.g. the aforementioned vehicle operation data itself, parameters that can be derived from the vehicle operation data, etc.). The evaluation parameters are determined in advance for each evaluation item, out of the plurality of parameters included in the vehicle data. Then, a plurality of primary components including the evaluation parameters are derived. In an example illustrated in FIG. 5, a first primary component to a 10th primary component are derived. Each of the various components has an eigenvalue indicating the extent of summarized information. The first primary component has the largest eigenvalue, and the eigenvalue decreases in ascending order, i.e., in order of first primary component, a second primary component, a third primary component, and so on. Since the principle component analysis is the existing analysis method, an explanation of a specific method of deriving the primary components is omitted.

As illustrated in FIG. 6, the first primary component includes evaluation parameters when “fuel consumption” is set as the evaluation item, out of the plurality of parameters included in the vehicle data. In an example illustrated in FIG. 6, the first primary component includes maximum speed in a predetermined period, maximum acceleration (or an average value of maximum acceleration G generated from acceleration to deceleration), average speed, maximum deceleration (or an average value of maximum deceleration G generated from deceleration to acceleration), maximum brake pressure (or an average value of maximum brake hydraulic pressure generated from brake lamp ON to OFF), maximum accelerator opening degree (or an average value of maximum accelerator opening degree generated from accelerator ON to OFF), number of times of brake ON (or number of times of changes from brake lamp ON to OFF), number of times of accelerator ON (or number of times when the accelerator opening degree becomes 0% from a value greater than 0%), brake ON time (or an average value of time from brake lamp ON to OFF), and steady running time (or an integrated value of time when acceleration |G|<0.1 m/s²).

The parameters that constitute the first primary component have respective different weightings. For example, in the example illustrated in FIG. 6, the maximum speed and the maximum acceleration or the like have positive weightings, while the brake ON time and the steady running time have negative weightings. The first primary component can be estimated to be, for example, a component indicating speed variation of the vehicle, from the respective parameters thereof.

In the example illustrated in FIG. 5, as is clear from the cumulative contribution ratio, only the first primary component has nearly half an entire information amount. Thus, if the first primary component is used to determine similarity of the driving characteristics, the grouping can be performed, extremely efficiently. In other words, without consideration of all the first primary component to the 10th primary component, relatively accurate grouping can be performed in view of only the first primary component (or only several primary components with large eigenvalues). Moreover, even if only the first primary component is considered, the plurality of parameters included in the vehicle data (i.e. the parameters that constitute the first primary component illustrated in FIG. 6) are considered. It is thus possible to determine the similarity of the driving characteristics, in comparison with when only a single parameter is considered.

As illustrated in FIG. 7, the grouping of the vehicle data is performed for each selectable evaluation item. Specifically, when “fuel consumption” is the evaluation item, the grouping is performed to provide “Group I (for fuel consumption)”, “Group II (for fuel consumption)”, and another or other groups, which have difference driving characteristics. In this case, fuel consumption data, which is the evaluation item, is stored in the control database 340, in addition to the vehicle data of vehicles that belong to the respective groups. On the other hand, when “smooth turning” is the evaluation item, the grouping is performed to provide “Group I (for smooth turning)”, “Group II (for smooth turning)”, and another or other groups, which have difference driving characteristics. In this case, turning data, which is the evaluation item, is stored in the control database 340, in addition to the vehicle data of vehicles that belong to the respective groups.

A result of the grouping illustrated in FIG. 7 is stored for each position located by the host vehicle locator 220. For example, results of the grouping using the vehicle data at a plurality of points may be separately stored, or the grouping results may be separately stored in accordance with road types (e.g. immediately before intersections, during curve running, etc.).

If a running route of the host vehicle, which is a control target, is known beforehand, the grouping may be performed only on the vehicle data that matches the running route of the host vehicle. For example, in controlling the host vehicle that enters a sharp curve, the grouping may be performed only on the vehicle data for sharp curve running. By narrowing in advance the vehicle data to be grouped, it is possible to reduce the number of data to deal with, and to realize various simplified processes related to the control. The narrowing of the vehicle data as described above may be performed, for example, by the driving characteristic index deriver 330. In this case, the driving characteristic index deriver 330 functions as one specific example of the “selector”. The driving characteristic index deriver 330 may obtain information about the running route of the vehicle from the in-vehicle system 10 side, for example, via the wireless receiver 310 or the like.

Back in FIG. 3, if the content of the control database 340 is restored in accordance with the result of the grouping, the grouping method is transmitted to the in-vehicle system 10 side from the management center 20 side (step S104). In other words, data transmission is performed from the wireless transmitter 350 to the wireless receiver 240. The grouping method is derived, for example, as a determination expression for determining whether or not each group condition is satisfied. For example, a determination expression of the “Group I (for fuel consumption)” is derived as Y=a×(vehicle speed)+acceleration . . . , wherein a and b are predetermined coefficients. If Y is greater than or equal to a predetermined threshold value, it is determined to belong to “Group I (for fuel consumption)”. As described above, by comparing Y calculated by the determination expression with one or a plurality of threshold values, the grouping can be well performed. In order to derive the determination expression and the threshold value(s), for example, determination analysis for the result of the grouping can be used. Moreover, the threshold value(s) can use a value(s) obtained by experiments or the like in advance. Since the determination analysis is an existing method, a specific explanation thereof is omitted here.

As is clear from the aforementioned explanation, the grouping method is not necessarily a method actually used for the grouping, but may be a classification method that can give the same result as that of the actual grouping. Specifically, even if various statistical analyses are used for the grouping, a determination expression derived from a result of the determination analysis may be used as the grouping method.

In FIG. 4, if the grouping method is received on the in-vehicle 10 side (step S201: YES), the group to which the host vehicle belongs is specified from a running history (or vehicle data) of the host vehicle (step S202). In other words, by applying the grouping method to the running history of the host vehicle, which group has driving characteristics similar to those of the host vehicle is specified from among the groups into which the vehicle data is divided on the management center 20.

After the specification of the group to which the host vehicle belongs, the information about the evaluation item set by the evaluation item setter 260 and the group to which the host vehicle belongs is transmitted to the management center 20 side from the in-vehicle system 10 side (step S203). In other words, data transmission is performed from the wireless transmitter 230 to the wireless receiver 310.

Back in FIG. 3, if the information about the evaluation item set in the in-vehicle system 10 and the group to which the vehicle equipped with the in-vehicle system 10 belongs is received (step S105: YES), the vehicle data of a group that matches the received evaluation item and the received group is transmitted from the management center 20 side to the in-vehicle system 10 side, out of the vehicle data stored in the control database 340 (step S106).

For example, if the evaluation item set in the in-vehicle system 10 is “fuel consumption” and the group to which the vehicle equipped with the in-vehicle system 10 belongs is “Group I (for fuel consumption)”, all the vehicle data of vehicles that belong to “Group I (for fuel consumption)” is transmitted to the in-vehicle system 10 from the management center 20. In the example illustrated in FIG. 7, the vehicle data of vehicles A, G, H and so on (including fuel consumption data) is transmitted.

Back in FIG. 4, if the vehicle data is received from the management center 20 side (step S204: YES), the vehicle data with the highest evaluation of the evaluation item is extracted from the received vehicle data by the vehicle data extractor 265 (step S205). For example, if the vehicle G has the highest fuel consumption among the received vehicle data of the vehicles A, G, H and so on, the vehicle data of the vehicle G is extracted. Technical effects described later can be reasonably obtained if vehicle data with higher evaluation of the evaluation item than that of the host vehicle is extracted, even though the vehicle data with the highest evaluation of the evaluation item is not extracted.

After the extraction of the vehicle data, it is determined whether or not the host vehicle is driving-supported (step S206). In other words, it is determined whether the implementation of the driving control by the vehicle control system (or driving support control) is allowed.

If it is determined that the host vehicle is driving-supported (the step S206: YES), the target vehicle state based on the extracted vehicle data is generated by the target vehicle state generator 270 (step S207). Then, the driving support control is performed by the driving system controller 280 in such a manner that the host vehicle is in the target vehicle state (step S208). For example, the control is performed in such a manner that the maximum speed, the maximum acceleration, the average speed, the maximum deceleration, the maximum brake pressure, the maximum accelerator opening degree, the number of times of brake ON, the number of times of accelerator ON, the brake ON time, and the steady running time are those in the extracted vehicle data with high fuel consumption.

The target vehicle state may not be a state in which a state of the host vehicle (i.e. running aspect) matches that of the extracted vehicle data, but may be a state in which the state of the host vehicle approaches to that in the extracted vehicle data. In this case, the state of the host vehicle approaches the state of the vehicle with high evaluation of the evaluation item to a greater or lesser extent. Thus, technical effects described later can be reasonably obtained.

On the other hand, if it is determined that the host vehicle is not driving-supported (the step S206: NO), it is estimated to what extent the vehicle data of the host vehicle is separated from the extracted vehicle data, and a result thereof is stored (step S209).

In this manner, when the host vehicle is changed to being driving-supported later, the vehicle can be controlled by using an evaluation result. In other words, it is possible to perform the control that allows the host vehicle to be in the target vehicle state, by using only the evaluation result, even without performing a series of process operations described above from the beginning.

### Effects of Embodiment

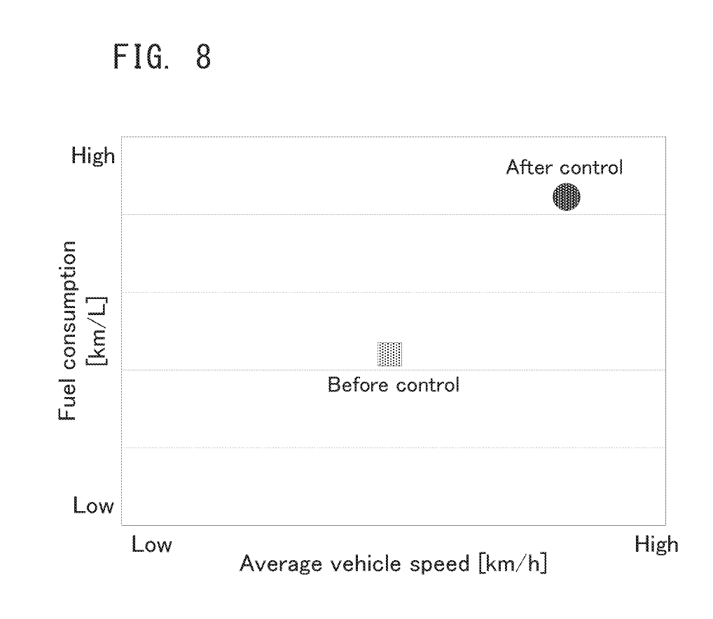

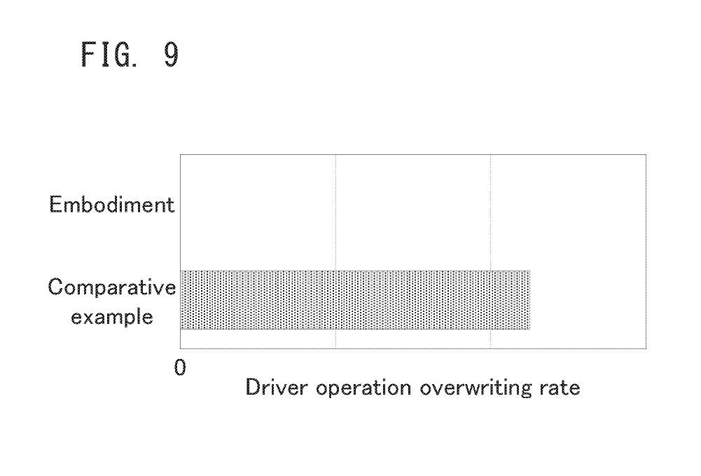

Lastly, technical effects obtained by the vehicle control system according to the embodiment will be explained in detail with reference to FIG. 8 and FIG. 9. FIG. 8 is a map illustrating variation in average vehicle speed and fuel consumption due to vehicle control. FIG. 9 is a graph illustrating a driver operation overwriting rate when the vehicle is controlled.

FIG. 8 illustrates an example in which the evaluation item is set to “fuel consumption”. Making a comparison of the vehicle state between before and after control by the vehicle control system according to the embodiment, it is clear that the average vehicle speed and the fuel consumption are higher after control than before control. The fuel consumption improves because the target vehicle state is generated on the basis of the vehicle data with the highest evaluation of the evaluation item (or with higher evaluation than that of the host vehicle) out of the vehicle data received from the management center 20 side. As described above, according to the vehicle control system in the embodiment, the evaluation item can be certainly improved by the running control of the vehicle.

FIG. 8 illustrates only the variation in average vehicle speed, but, in fact, the control is performed in such a manner that a plurality of parameters, as illustrated in FIG. 6, respectively vary in accordance with the extracted vehicle data. Thus, in comparison with when a single parameter varies, the fuel consumption can be improved.

Particularly in the embodiment, the control is performed on the basis of the vehicle data extracted from the group with driving characteristics similar to those of the host vehicle. It is thus possible to suppress significant variation in the driving characteristics based on the presence or absence of the control. It is therefore possible to prevent that the driver feels discomfort for vehicle behavior after control. Specifically, it is possible to prevent that sudden braking is applied by the control even though the driver prefers mild braking and that the driver feels discomfort. In the embodiment, a plurality of types of information about the vehicle operation is considered in the grouping. Thus, the grouping can be performed, more preferably, than when only one type of information about the vehicle operation is considered.

As illustrated in FIG. 9, in a comparative example in which the grouping is not performed in advance (specifically, in such a configuration that the vehicle data with high evaluation of the evaluation item is extracted from all the vehicle data stored in the running history database 320), it is clear that an operation overwriting rate (or overriding rate) by the driver upon control is relatively high. This indicates that the driver of the vehicle feels discomfort for the vehicle behavior upon control and frequently performs the driving operation to eliminate the discomfort.

On the other hand, in the embodiment, the driver operation writing rate is zero (or is relatively low depending on circumstances). It can be thus predicted that the driver's discomfort for the vehicle behavior upon control can be effectively suppressed.

As explained above, according to the vehicle control system in the embodiment, the driving support control allows the evaluation item to be improved without giving discomfort to the driver.

The invention may be embodied in other specific forms without departing from the spirit or essential characteristics thereof. The present embodiments and examples are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A vehicle control system comprising:
a database configured to store therein, for each vehicle, vehicle data including a plurality of types of information about vehicle operation;
a group divider configured to divide the vehicle data of a plurality of vehicles into groups each of which includes similar driving characteristics;
a specifier configured to specify to which of the groups a host vehicle belongs, from a running history of the host vehicle;
an extractor configured to extract the vehicle data of a vehicle with higher evaluation regarding a predetermined evaluation item, which can be evaluated by using the vehicle data, than that of the host vehicle, from the group specified by said specifier; and
a controller configured to control a running aspect of the host vehicle in such a manner that the running aspect approaches to a running aspect performed on the basis of the vehicle operation indicated by the vehicle data extracted by said extractor.

2. The vehicle control system according to claim 1, wherein
said database and said group divider are provided for an external server configured to communicate with the host vehicle, and
said specifier, said extractor, and said controller are provided for the host vehicle.

3. The vehicle control system according to claim 1, wherein
said database, said group divider, said specifier, and said extractor are provided for an external server configured to communicate with the host vehicle, and
said controller is provided for the host vehicle.

4. The vehicle control system according to claim 1, wherein
said vehicle control system further comprises a selector configured to select vehicle data including information about vehicle operation performed on a route on which the host vehicle is scheduled to run, from the vehicle data stored in said database, and
said group divider is configured to divide the vehicle data selected by said selector, into groups.

5. The vehicle control system according to claim 1, further comprising a changer configured to change the predetermined evaluation item.
